(19) United States
(12) Patent Application Publication
(10) Pub. No.: US 2005/0008549 A1
(43) Pub. Date: Jan. 13, 2005

(54) Photocatalytic lamp

(76) Inventor: Fu-Yu Hsu, TaoYuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/614,164

(22) Filed: Jul. 8, 2003

(51) Int. Cl. B01J 19/08; B01J 19/12

(52) U.S. Cl. 422/186

(57) ABSTRACT

A photocatalytic lamp is constructed to include a lamp body and a photocatalyst covering surrounding the lamp body, the photocatalyst covering being formed of a photocatalyst-coated breathing base material, which has a plurality of protruding flow guide portions that define with the periphery of the lamp body a respective buffer zone adapted to buffer the flowing of air.

### BACKGROUND OF THE INVENTION

1. Field of the Invention

The present invention relates to sterilizing lamps and, more specifically, to a photocatalytic lamp, which is comprised of a lamp body, and a photocatalyst covering formed of a photocatalyst-coated breathing base material, which has a plurality of protruding flow guide portions that define with the periphery of the lamp body a respective buffer zone adapted to buffer the flowing of air.

2. Description of the Related Art

Following fast development of industries and increase of the number of motor vehicles, the problem of air pollution becomes more and more series in most countries around the world. In order to breathe clean air, air conditioners, air purifiers, ventilators with wire gauze filters and the like may be used. However, these devices can simply remove solid matters from air. In recent years, various nanostructured photocatalysts have been developed for use with ultraviolet light sources to sterilize air. When a photocatalyst radiated by ultraviolet light, oxygen and water in air are caused to react and to produce negative oxygen ions and hydroxide free radicals. When encountered organic substances in air, negative oxygen ions transfer electrons to organic substances, and hydroxide free radicals catch electrons from organic substances. During the process, organic substances are caused to decompose into carbon dioxide and water. By means of the aforesaid chemical reaction, photocatalysts cause an oxidation to kill germs in air.

Various photocatalytic sterilizing products have been commercialized. However, the structural or space arrangement between the catalyst (for example, TiO₂) and the light source (for example, ultraviolet lamp) affects the sterilizing effect.

FIGS. 1A-1C show a photocatalytic lamp according to the prior art. This structure of photocatalytic lamp is comprised of an UV lamp tube 11 and a photocatalyst coating 12 covered on the surface of the UV lamp tube 11. Because the photocatalyst coating 12 covers the whole area of the surface of the UV lamp tube 11 (except the base at each end of the lamp tube), less amount of UV energy passes out of the photocatalyst coating 12, resulting in a low photocatalyst ionizing (activating) effect. There are other related prior art patents, which include U.S. Pat. Nos. 6,135,838 and 6336998. Further, because the photocatalyst coating 12 is smoothly covered on the surface of the UV lamp tube 11, currents of air pass over the surface of the photocatalytic lamp rapidly, resulting in a short air and photocatalyst contact time. Therefore, this design of photocatalytic lamp is less effect in killing germs in air.

In order to extend the contact time of catalyst with air, another structure of photocatalytic lamp is developed. According to this design, the photocatalytic lamp comprises an UV lamp body and a photocatalytic light guide. The photocatalytic light guide is a formed of a panel like a honeycomb in structure. However, this design of photocatalytic lamp is still not satisfactory in function because the photocatalyst at the rear end of the photocatalytic light guide cannot receive sufficient radiation of ultraviolet light from the UV lamp body.

There is still known another structure of photocatalytic lamp, which uses a photocatalyst filter as covering means for the lamp. The photocatalyst filter is a substrate having openings in it. Due to the formation of the openings in the substrate, the structural strength of the photocatalyst filter is weakened. Further, when passing through the area around the openings in the substrate, air tends to be disturbed, forming a turbulent flow of air, which causes noises.

### SUMMARY OF THE INVENTION

The present invention has been accomplished under the circumstances in view. It is the main object of the present invention to provide a photocatalytic lamp, which kills germs in air by means of a photocatalytic effect. It is another object of the present invention to provide a photocatalytic lamp, which has buffer zones to buffer the flowing of circulating air.

To achieve these and other objects of the present invention, the photocatalytic lamp comprises a lamp body, and a photocatalyst covering surrounding the lamp body. The photocatalyst covering comprises a breathing base material, and a photocatalyst in the breathing base material. The breathing base material has protruding flow guide portions each defining with the periphery of the lamp body a respective buffer zone adapted to buffer the flowing of circulating air. In one embodiment of the present invention, the flow guide portions extend in radial direction. In another embodiment of the present invention, the flow guide portions extend in axial direction.

### BRIEF DESCRIPTION OF THE DRAWINGS

FIG. 1A is an elevational view of a photocatalytic lamp according to the prior art.

FIG. 1B is a cross-sectional view in an enlarged scale of the photocatalytic lamp shown in FIG. 1.

FIG. 1C is a longitudinal view in section in an enlarged scale of a part of the photocatalytic lamp shown in FIG. 1.

FIG. 2A is a schematic drawing showing the structure of a photocatalytic lamp according to the present invention.

FIG. 2B is a schematic drawing showing an alternate form of the photocatalytic lamp according to the present invention.

FIG. 3 is a schematic drawing showing a circulation of air through one buffering zone in the photocatalytic lamp according to the present invention.

FIG. 4 is a perspective view of another alternate form of the photocatalytic lamp according to the present invention.

FIG. 5 is a perspective view of still another alternate form of the photocatalytic lamp according to the present invention.

FIG. 6 is a schematic drawing of still another alternate form of the photocatalytic lamp according to the present invention.

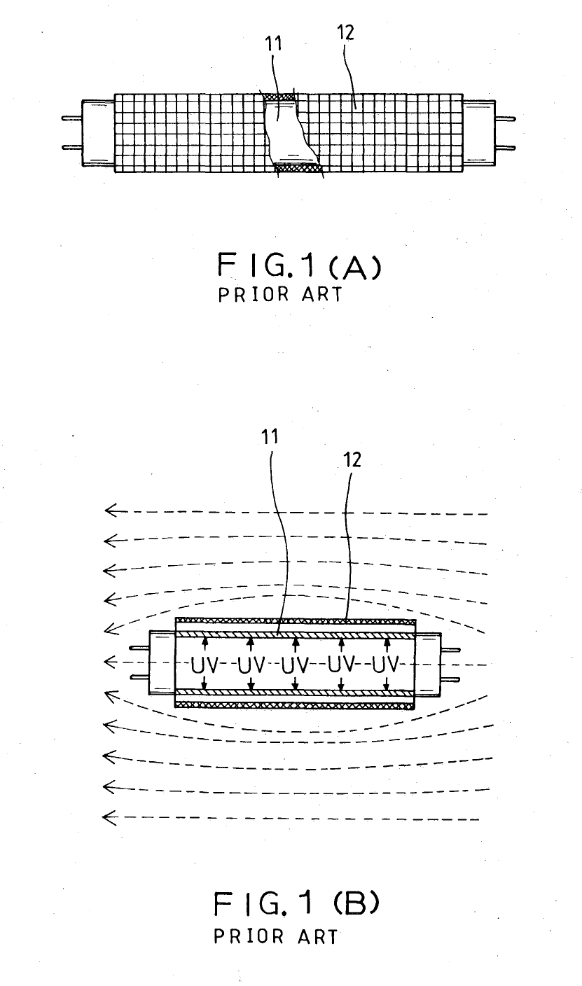

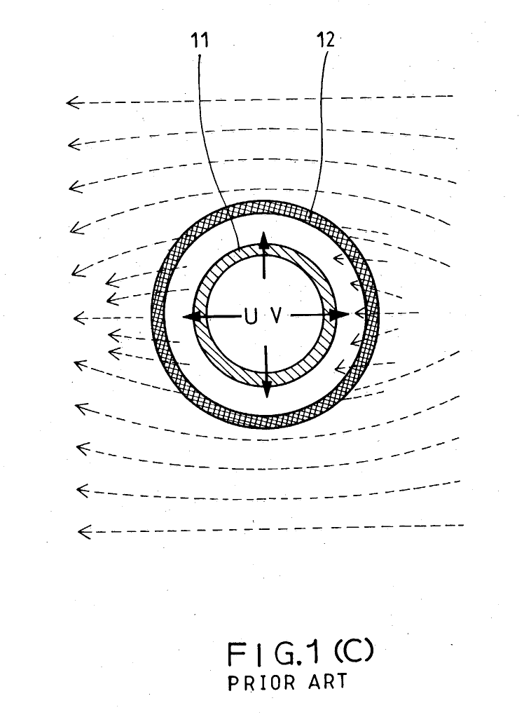

### DETAILED DESCRIPTION OF THE PREFERRED EMBODIMENT

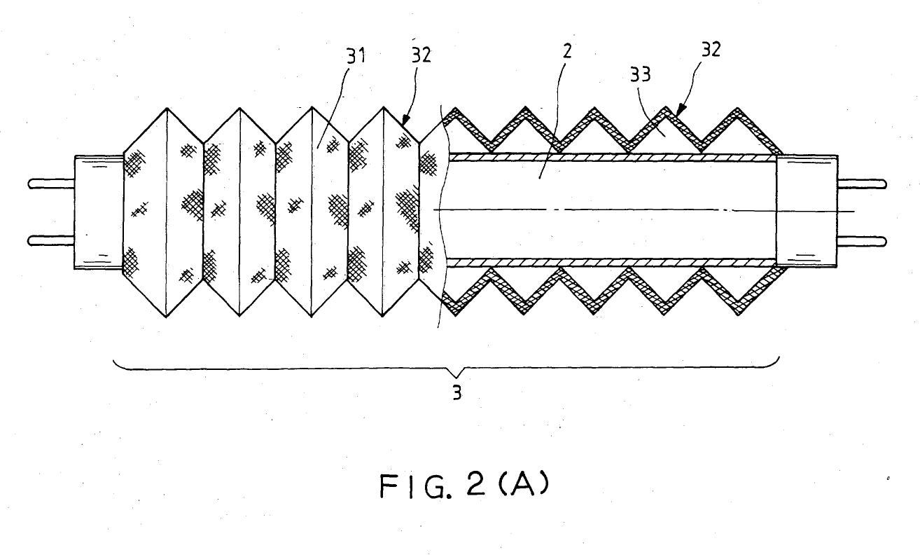

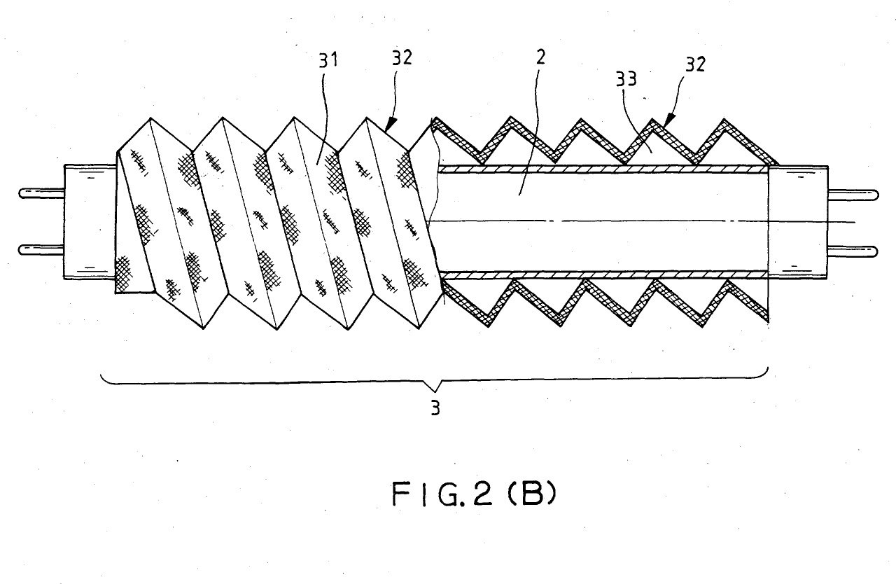

Referring to FIGS. 2A and 2B, a photocatalytic lamp is shown comprising a lamp body 2 and a photocatalyst covering 3 formed of a breathing base material 31 attached with a photocatalyst and covered on the surface of the lamp body 2. The breathing base material 31 is a thin sheet member selected from any of a variety of materials including non-woven fabric, polymeric sheet material, metal netting, filter paper, ceramics, and sponge. The photocatalyst can be obtained from any of a variety of oxide compounds such as TiO₂, ZnO, SnO₂, SrTiO₃, WO₃, Bi₂O₃, and Fe₂O₃. The best choice is TiO₂. Most preferably, TiO₂ is selected.

The aforesaid photocatalyst can be mixed in the breathing base material 31 during the fabrication of the breathing base material 31. Alternatively, the photocatalyst can be coated on the surface of the breathing base material 31.

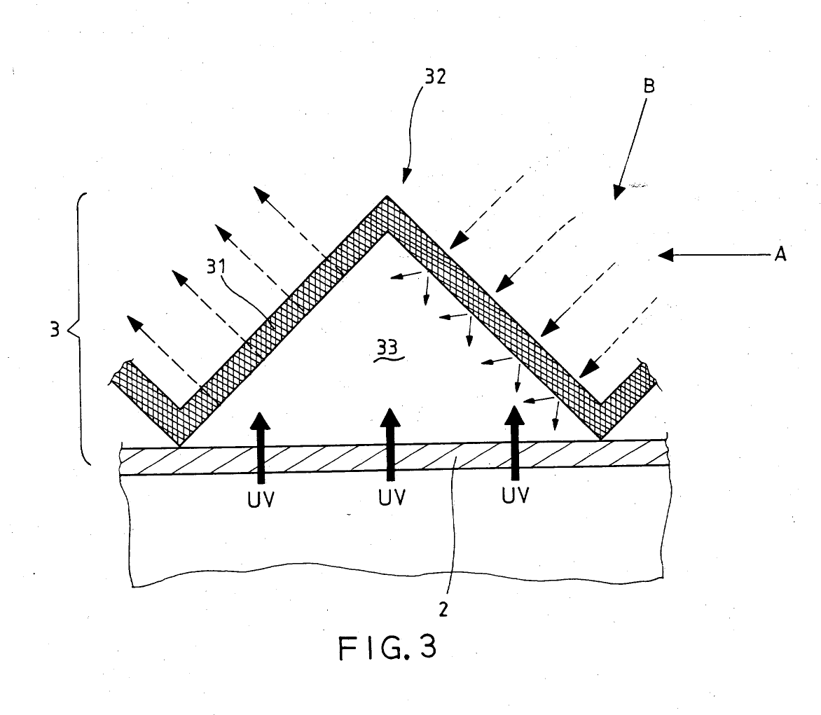

Referring to FIG. 3 and FIG. 2A, unlike the smooth tube-like conventional designs, the photocatalyst covering 3 is shaped like a corrugated tube having a plurality of protruded flow guide portions 32. Each protruded flow guide portion 32 defines with the periphery of the lamp body 2 a flow buffer zone 33. When currents of air pass through the photocatalyst covering 3 either from direction A or direction B, the buffer zones 33 buffer the flowing speed of currents of air, and at the same time, the radiation of light from the lamp body 2 excites the photocatalyst at the breathing base material 31 of the photocatalyst covering 3, producing an ionized effect to sterilize air.

The aforesaid lamp body 2 can be formed of a lamp tube lamp bulb, or LED (light emitting diode) having a wavelength within 200˜800 nm. Preferably, the lamp body 2 is formed of a UV (ultraviolet) lamp tube, UV lamp bulb, or UV LED (light emitting diode).

In the embodiment shown in FIG. 3, the lamp body 2 is formed of a UV lamp tube, which emits UV light to kill germs in air and to excite the photocatalyst at the breathing base material 31 of the photocatalyst covering 3, achieving a photodissociation effect. Because the buffer zones 33 buffer the flowing speed of air and because currents of air are continuously circulated through the photocatalyst covering 3, the invention effectively kill germs in air and remove bad smell from air.

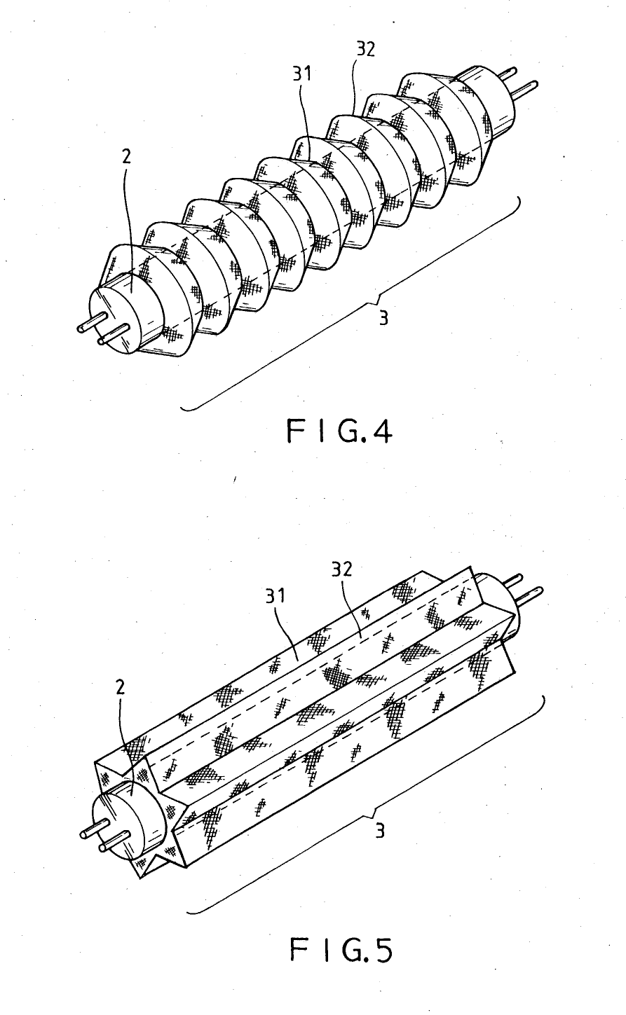

The protruded flow guide portions 32 may be variously embodied. According to the embodiments shown in FIGS. 2A and 4, the protruded flow guide portions 32 are arranged in parallel around the periphery of the lamp body 2. According to the embodiment shown in FIG. 2B, the protruded flow guide portions 32 are spirally connected in series around the periphery of the lamp body 2. According to the embodiment shown in FIG. 5, the protruded flow guide portions 32 extend in axial direction, and are arranged in parallel around the periphery of the lamp body 2.

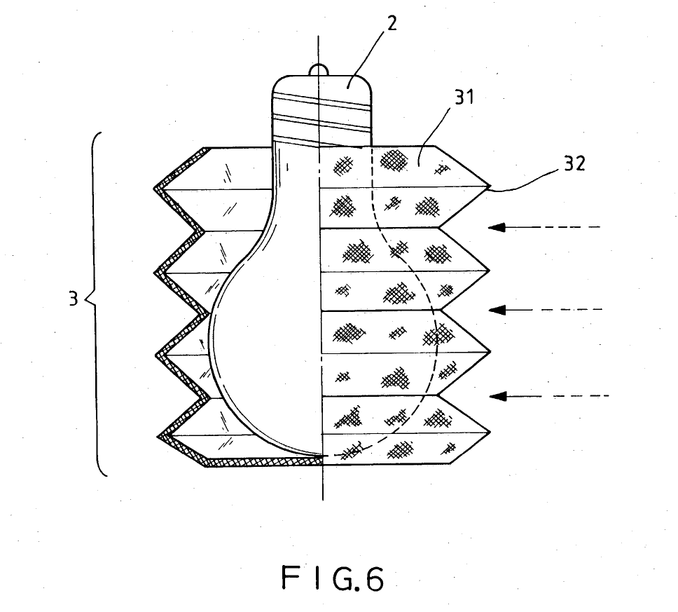

FIG. 6 shows still another alternate form of the present invention. According to this embodiment, the lamp body 2 is formed of a lamp bulb, and the photocatalyst covering 3 comprises a plurality of protruded flow guide portions 32 arranged in parallel around the periphery of the lamp body 2.

Further, the photocatalyst covering 3 may be used with an existing lamp tube (or lamp bulb). Because the breathing base layer 31 admits air and light, the photocatalyst covering 3 does not block the light of the lamp tube (or lamp bulb), and the photocatalytic lamp provides sufficient illumination when sterilizing air.

A prototype of photocatalytic lamp has been constructed with the features of FIGS. 2˜6. The photocatalytic lamp functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A photocatalytic lamp comprising a lamp body and a photocatalyst covering surrounding said lamp body, wherein said photocatalyst covering comprising a breathing base material and a photocatalyst in said breathing base material, said breathing base material having at least one protruding flow guide portion each defining with the periphery of said lamp body a respective buffer zone adapted to buffer the flowing of air.

2. The photocatalytic lamp as claimed in claim 1, wherein said breathing base material is a thin sheet material selected from a group of materials including non-woven fabric, polymers, metal netting, filter paper, ceramics, and sponge.

3. The photocatalytic lamp as claimed in claim 1, wherein said photocatalyst is selected from an oxide compound group including TiO₂, ZnO, SnO₂, SrTiO₃, WO₃, Bi₂O₃, and Fe₂O₃.

4. The photocatalytic lamp as claimed in claim 1, wherein said photocatalyst is mixed in said breathing base material.

5. The photocatalytic lamp as claimed in claim 1, wherein said photocatalyst is fastened to said breathing base material by coating.

6. The photocatalytic lamp as claimed in claim 1, wherein said lamp body is a lamp tube.

7. The photocatalytic lamp as claimed in claim 1, wherein said lamp body is a lamp bulb.

8. The photocatalytic lamp as claimed in claim 8, wherein said lamp body is a light emitting diode.

9. The photocatalytic lamp as claimed in claim 1, wherein said lamp body emits ultraviolet light.

10. The photocatalytic lamp as claimed in claim 9, wherein the wavelength of the light emitted by said lamp body is within 200˜800 nm.

11. The photocatalytic lamp as clamed in claim 1, wherein said breathing base material has a plurality of protruding flow guide portions extended around the periphery of said lamp body.

12. The photocatalytic lamp as claimed in claim 1, wherein said breathing base material has a plurality of protruding flow guide portions extend in axial direction relatively to said lamp body and arranged in parallel.
